(19) United States
(12) Patent Application Publication
(10) Pub. No.: US 2004/0031057 A1
(43) Pub. Date: Feb. 12, 2004

(54) Method and system for providing media content

(76) Inventor: Christopher P Waites, Medford, MA (US)

Correspondence Address: GREENBERG TRAURIG, LLP, 885 3RD AVENUE, NEW YORK, NY, 10022, US

(21) Appl. No.: 10/416,176

(22) PCT Filed: Apr. 23, 2001
(86) PCT No.: PCT/US01/12958

(51) Int. Cl. H04N 7/173

(52) U.S. Cl. 725/110; 725/112; 725/131

(57) ABSTRACT

An improved method of providing media content to at least one user comprising the steps of accessing by the user of a server/provider website via a set-top box, and selecting by the user of media content stored in a server/provider database, and delivery of the selected media content to the user set-top box by the server/provider.

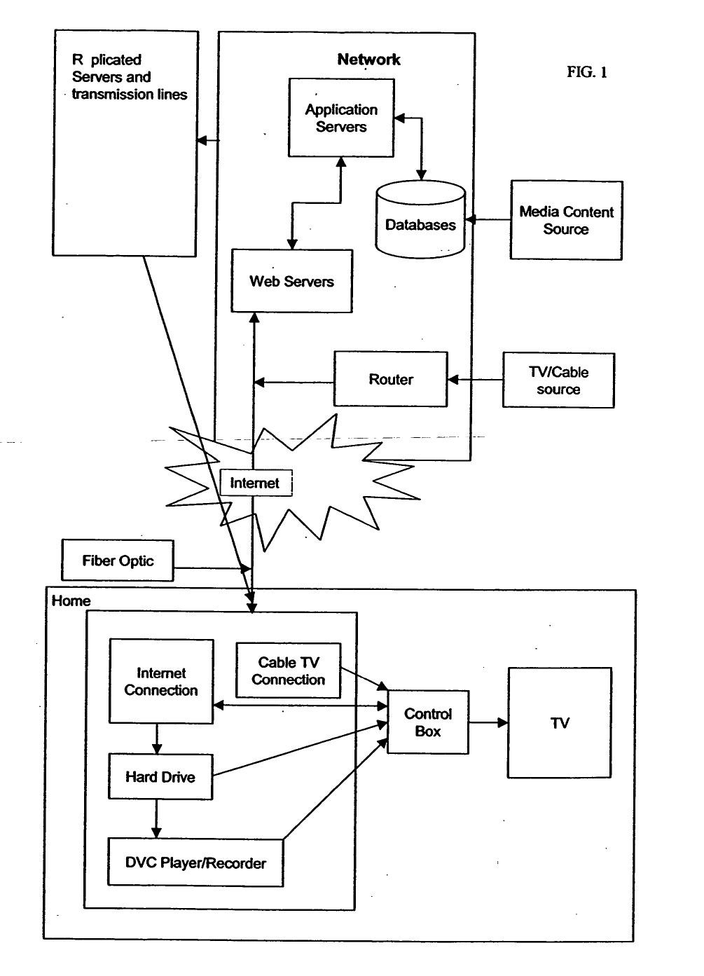

### CROSS-REFERENCE TO RELATED APPLICATIONS

This application claims priority from Waites, “Method and System for Providing Media Content,” U.S. Provisional Application No. 60/249,925, filed Nov. 17, 2000, herein incorporated by reference.

### FIELD OF THE PRESENT INVENTION

The present invention relates to a method and system to acquire media content, comprising, for example, movies, music, and video games, from national distributors, or in some cases, directly from the studios, record companies, and/or manufacturers and to provide this media content through the a network to customers. The acquisition and delivery of this content is described in this document.

### SUMMARY OF THE INVENTION

Media content will be delivered from distributors/manufacturers to a server/provider on tape, DVD, disc or other medium. In most cases the content will be delivered over the Internet. The server will provide the infrastructure to receive this media content.

In addition, broadcast television will be routed through the server/provider for delivery to customers. The transmission from the broadcast television providers to server/provider will, initially, be adapted to the broadcast television providers existing infrastructure. As television broadcast evolves into Digital TV, this segment of the transfer will be modified appropriately by the server/provider. The transmission of the broadcast television content from the server/provider to customers will occur via infrastructure provided by the server/provider.

The media content described above will be stored on database servers. The content will be copied to the database in digital format. The server/provider will host application and web servers at a secure, high-availability co-hosting location. Customers will access the server/provider web site on these web servers through the Internet. The application servers will manage the selection, rental, sale, and delivery of the movies/music/games. Customers will be able to find and request movies/music/games by Actor, Director, Title, Category, Style, or other suitable criteria from this database. The web customer interface provided by the server/provider will facilitate selection and ordering. Ordering may be for rental or, in certain cases, purchase.

Data transfer to and from server/provider will take place across fiber optic cable. This fiber optic cable network will go all the way into the customer's home, and connect to a set-top box. It is also contemplated that the set top box can provide (replace) the function of a video tape recorder. The instant set box will comprise hardware and software capable of recording media content on a drive in the set top box for replay and a future time.

The set-top box will be provided by the server/provider, in collaboration with various hardware, software, and telecommunications experts. The set-top box will remain the property of the server/provider and is installed, along with the installation of fiber optic cable into the customer's home. There will be an installation fee and a deposit required.

The server/provider set-top box will replace the customer's cable box. It will supply Internet connection, through the server/provider. It will also provide a cable TV connection. As an extra-cost option, the set-top box will contain a DVD player/recorder. Movies/music/games can be purchased from the server/provider and recorded onto CD's/DVD disk right on the set-top box.

The server/provider control box will control the TV and all the devices in the set-top box, thereby replacing multiple remote controls for the customer.

A typical scenario would be as follows: A customer presses a button on the control box that navigates to the server/provider website via the server/provider network. The user sees the server/provider login screen on a TV set. All interaction with the server/provider is through the customer's TV, by way of the set-top box, controlled by the controller box. If the customer is new, he is routed to a web page that allows him to become a member. A credit card is registered for that customer. At this point the customer is allowed to enter a username, and the system issues a password for that customer. A registered customer goes to a page that allows him to select movies, music, or video games. If the customer indicates that he wishes to choose a movie, he is then taken to a page that allows him to choose a movie. In choosing a movie, the customer is able to search by actor, director, year of release, genre, rating, or one of several other criteria. Once the customer chooses the movie, it is added to his “basket”. Several movies, music selections, and/or video games can be added to the “basket” in similar fashion. The customer can click a button to check out. After a brief confirmation message, the customer can check this item or items out and his credit card, debit card or smart card is charged for the purchase or purchases. At this point the servers retrieve the digital images of the selected media content, i.e., movie(s)/music/game(s) and begins transmission. In the case of a movie, as an example, the movie is transmitted across the fiber optic network to the set-top box in the customer's home. The set-top box stores the digital image of the movie to its internal hard disc. At this point the user can play the movie on his TV, to which the set-top box is connected. The playback is controlled by the controller box. The customer can begin playback at any time. Once playback begins, a timer within the set-top box is started. From this point in time, the customer has use of this music for a set period of time (say, two weeks). During that time period, the customer can start, stop, rewind, and replay the movie at will. Once the time period has expired, the movie will be marked for deletion from the set-top hard disc. After this point in time, the next time the customer accesses a server/provider function from the set-top box (for example, to play a movie or a music track), the system will display a message on the TV screen informing the user that the movie has expired, and asking the customer if he wishes to purchase the movie. If the customer answers “No,” the system deletes the movie from the hard disc. If the customer answers “Yes,” the system displays a screen (a web page at the server/provider) that allows the customer to purchase the movie.

A similar scenario would exist for music and video games.

The attached figure has been generally described above and is provided to illustrate an embodiment of the present invention. It should be understood that the illustrative embodiment is not limiting and those skilled in the art would recognize various equivalent embodiment that could also be used and which would be in the scope of this invention.

The invention to be claimed is:

1. A method of providing media content to at least one user comprising the steps of:
(a) accessing by the user of a server/provider website via set-top box;
(b) selecting by the user of media content stored in a server/provider database; and
(c) delivering of the selected media content to the user set-top box by the server provider.

2. The method of claim 1, wherein the accessing is via the Internet.

3. The method of claim 1, wherein the user set-top box further comprises a DVD player/recorder.

4. The method of claim 1, wherein the data transfer between the user and the server/provider is via fiber optic cable.

5. The method of claim 1, wherein a server/provider control box controls a user's TV and external devices connected to the TV as well as all devices in the user set-top box.

6. The method of claim 1, wherein the media content provided by the server/provider is stored in the user set-top box.

7. The method of claim 6, further comprising deleting the stored media content after a preselected time period.
